(19) United States
(12) Patent Application Publication
(10) Pub. No.: US 2004/0011572 A1
(43) Pub. Date: Jan. 22, 2004

(54) Vehicle dynamic ride control

(76) Inventor: Damian A Harty, Banbury Oxfordshire (GB)

Correspondence Address: NIXON & VANDERHYE, PC, 1100 N GLEBE ROAD, 8TH FLOOR, ARLINGTON, VA, 22201-4714, US

(21) Appl. No.: 10/333,792

(22) PCT Filed: Jul. 30, 2001
(86) PCT No.: PCT/GB01/03422

(30) Foreign Application Priority Data
Aug. 1, 2000 (GB) 0018790.6

(51) Int. Cl. B62D 6/00

(52) U.S. Cl. 180/6.2

(57) ABSTRACT

A vehicle is controlled to limit the effect of the yaw on vehicle manoeuvres by having at least one pair of driving (17, 18) mounted on drive shafts (23, 24) which are interconnected by control means whereby to adjust the relative rotational speeds of the wheels of the pair. The control means may be in the form of a differential 15 by which the locking factor of the differential is adjustable to control said relative speeds in accordance with the driving manoeuvre sensed by sensors (19, 20, 21).

The present invention relates to a vehicle control and particularly, but not exclusively, to a method of controlling the operation and movement of a vehicle which provides both stability and agility to the vehicle.

Vehicle yaw (rotation of a vehicle about a vertical axis), poses a considerable danger to drivers during extreme or evasive vehicle manoeuvres. It can be shown that the amount of yaw damping inherent in a vehicle has a direct effect on the ability of the driver to regain and/or maintain control of the vehicle. Many modern vehicles are provided with sophisticated yaw control systems which selectively adjust the braking force applied to each wheel to reduce the yaw in the vehicle.

The present invention aims to provide an improved method of vehicle control.

Accordingly, the present invention provides a method of controlling a vehicle, the vehicle having at least one drive assembly, said drive assembly comprising at least one pair of driving wheels with the wheels of the pair located at opposite sides of the vehicle, drive shaft means drivingly connected to each of the wheels of the pair for selectively applying torque thereto, and control-means interconnecting the respective drive shaft means to adjust the relative rotational speeds of the wheels of said pair, the method comprising the steps of selectively sensing movement of the vehicle, the steering angle of the vehicle wheels and/or the rotation of the steering wheel of the vehicle and generating a control signal in response thereto and controlling the relative rotational speeds of the wheels in said pair in response to the control signal, thereby to control the vehicle.

Conveniently, the control means comprises a differential or the like. Preferably, the step of adjusting the differential includes adjusting the cross-axle locking state or locking factor of the differential.

Advantageously, the control signal generated is based upon the movement of the vehicle, for example yaw rate, side slip, lateral and longitudinal acceleration and/or vehicle velocity. Alternatively, or additionally, the control signal generated is based on the steering angle of the vehicle and/or the input from the driver to the steering wheel such as the rate of change of movement of the steering wheel.

Alternatively, the control means comprises at least one drive means such as an electric motor, and a control unit for controlling the drive from the drive means to each drive shaft means.

Conveniently, the movement of the vehicle can be sensed by means of conventional sensors located within the vehicle. Advantageously, the method does not require the use of any hardware additional to that conventionally provided on a vehicle.

The present invention will be described, by way of example only, with reference to the accompanying drawing which shows in plan view a schematic layout of a four-wheel drive vehicle.

Although the following description is made with reference to a four-wheel drive vehicle, it will be apparent to those skilled in the art that the invention can equally be applied to front-wheel or rear wheel drive vehicles.

Many road vehicles, particularly those having rear-wheel or four-wheel drive transmissions, are provided with devices designed to improve the power transmission through the wheels to the road surface under conditions of marginal grip.

The most common form of devices for this purposes are known as differentials. Conventionally, differentials are geared units which compensate for differences in the respective rotational speeds of-the drive wheels, for example between inside and outside wheels during cornering and between different drive axles on four-wheel drive vehicles. A common form of differential is known as a limited slip differential which reduces or prevents wheel spin by employing friction plates, friction cones, self-locking gears or multi-plate units in a high-viscosity fluid to lock together the output shafts or drive axles providing drive to the wheels to reduce relative rotation between the wheels or to cause the wheels to rotate at the same speed.

Such differentials may be of various kinds which can be adapted with the invention but without necessarily affecting their normal function. Control means may be employed, by way of example, may be selected from those described in US-A-4273206, EP-A-0575152, GB-A-2015666, GB-A-2119328 and GB-A-2221518.

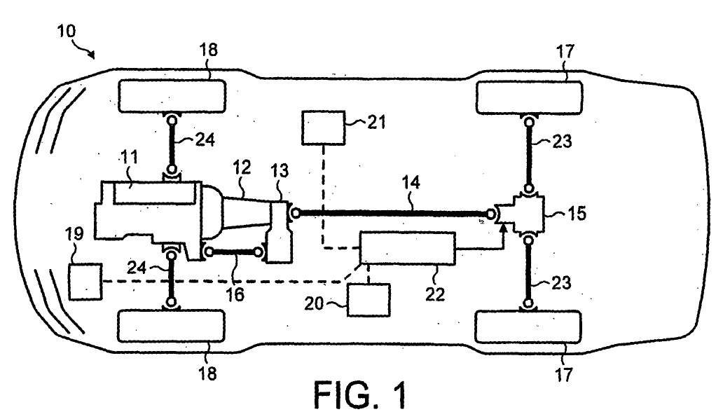

Referring to FIG. 1, a vehicle is shown in schematic form generally at 10. The vehicle has a front-mounted engine 11 which is connected to a gearbox 12 for transmitting drive from the engine to the wheels. The gearbox 12 is connected to a transfer case 13 for splitting drive from the gearbox 12 between the front and rear pairs of wheels. The transfer case is connected via a main rear drive shaft 14 to a rear differential 15 for selectively transmitting drive to each of the rear pairs of wheels 17 via respective rear drive axles 23. In addition, the transfer case 13 is connected via a main front drive shaft 16 to a front differential (not shown) for providing drive to the front pair of wheels 18 of the vehicle via respective front drive axles 24.

The vehicle has a number of sensors for sensing the movement of the vehicle. In FIG. 1 there is provided a sensor 19 for sensing the yaw rate of the vehicle, a sensor 20 for sensing the longitudinal and lateral acceleration of the vehicle and a sensor 21 for sensing the steering angle of the vehicle wheels and rate of rotation of the steering wheel. The sensors 19, 20 21 are connected to a control unit 22 which controls operation of the rear differential 15 and the front differential (not shown).

As indicated above, the components of the vehicle represented by reference numerals 11 to 22 in FIG. 1 are conventional to many vehicles, especially those that provide certain levels of yaw control to the vehicle. However, such systems generally rely upon adjusting the braking to individual wheels in order to provide yaw control.

According to the present invention, however, the control unit 22 acts to control the front and rear differentials to adjust the relative rotational speeds of the respective front and rear pairs of wheels according to signals generated by the sensors 19, 20, 21. In a preferred embodiment, the cross-axle locking state of the differential, also known as the locking factor i.e. the relative rotational speeds of the wheels at which the differential acts to lock the drive axles to each wheel in a pair together, is adjusted by the control unit 22.

Advantageously, since operation of the differentials is based on movement of the vehicle rather than individual wheel spin, this can be used to control motion of the vehicle to provide stability and yaw damping.

In a further embodiment, the driver's input to the steering wheel, i.e. steering wheel movement and the rate of change of movement, is monitored by the sensor 21 and, by using a suitable algorithm, the control unit 22 can determine what driving manoeuvre the driver is trying to cause. The control unit 22 is then able to adjust the state of the differential(s) to assist the driver in achieving the manoeuvre. For example, a rapid rotation of the steering wheel by the driver could be interpreted by the control unit 22 as an attempt cause a sharp turn. The control unit 22 is then operable to adjust the differentials to cause faster rotation of the outer wheels than the inner wheels thereby to assist the driver in turning the vehicle.

It can be seen that by manipulating the differentials of the vehicle, the vehicle can be made more stable and the advantages of other more complex and expensive yaw control systems can be provided. In addition, by actively controlling the relative rotation of each wheel of a pair of wheels on the vehicle the system is able to increase the agility of the vehicle by sensing the intended manoeuvre of the driver and operating the associated differential accordingly. The system thus provides greater versatility than existing yaw control systems which employ wheel-braking methods to provide yaw control.

It will be appreciated that the system and method described does not preclude the use of adjustable brake torque for yaw control. It is envisaged that both systems may be employed simultaneously to improve driving safety and pleasure. It will also be appreciated that the above-described method is not limited to use with vehicles having conventional drivelines i.e. combustion engines and mechanical transmissions, it is equally applicable to vehicles having, for example, electric drive to each wheel.

In addition, the system and method does not prejudice the use of the differentials, or any other components of the vehicle, in their normal mode.

1. A method of controlling a vehicle, the vehicle having at least one drive assembly, said drive assembly comprising at least one pair of driving wheels with the wheels of the pair located at opposite sides of the vehicle, drive shaft means drivingly connected to each of the wheels of the pair for selectively applying torque thereto, and control means interconnecting the respective drive shaft means to adjust the relative rotational speeds of the wheels of said pair, the method comprising the steps of selectively sensing movement of the vehicle, the steering angle of the vehicle wheels and/or the rotation of the steering wheel of the vehicle and generating a control signal in response thereto and controlling the relative rotational speeds of the wheels in said pair in response to the control signal, thereby to control the vehicle.

2. A method according to claim 1 wherein the control means comprises a differential and the differential is controlled by adjusting the cross-axle locking state or locking factor of the differential.

3. A method according to claim 1 or 2 wherein the control signal generated is based upon the movement of the vehicle, selected from yaw rate, side slip, lateral acceleration, longitudinal acceleration and/or vehicle velocity.

4. A method according to any one of the preceding claims wherein the control signal generated is based on the steering angle of the vehicle and/or the input from the driver to the steering wheel related to the rates of change of movement of the steering wheel.

5. A method according to any one of the preceding claims wherein the movement of the vehicle is sensed by sensing means located within the vehicle such as lateral and/or longitudinal accelerometers, vehicle speed sensors and/or wheel steering angle sensors.

6. A vehicle having a drive assembly which comprises at least one pair of driving wheels with the wheels of the pair located at opposite sides of the vehicle, drive shaft means, drivingly connected to each of the wheels of the pair for selectively applying torque thereto, and control means interconnecting the respective drive shaft means to adjust the relative rotational speeds of the wheels of said pair, the control means comprising a differential by which the relative rotational speeds of the wheels in said pair is controlled in response to the control signal, thereby to control the vehicle.
